(19) United States
(12) Patent Application Publication
(10) Pub. No.: US 2024/0065922 A1
(43) Pub. Date: Feb. 29, 2024

(54) A MULTI-FUNCTIONAL MAGNETIC CLIP, HOOK, AND PEDAL DEVICE FOR CRUTCHES, CANES AND OTHER STICK-LIKE OBJECTS

(71) Applicant: Leigh BOYD, St. Catharines (CA)

(72) Inventor: Leigh BOYD, St. Catharines (CA)

(73) Assignee: Leigh BOYD, St Catharines, ON (CA)

(21) Appl. No.: 18/548,560

(22) PCT Filed: Mar. 2, 2022
(86) PCT No.: PCT/SE2022/050208

§ 371 Date: Aug. 31, 2023

(30) Foreign Application Priority Data
Mar. 3, 2021 (SE) 2150240-6

(51) Int. Cl. A61H 3/02; A45B 3/00; A45B 9/04

(52) U.S. Cl. CPC A61H 3/0288; A45B 3/00; A45B 9/04; A61H 3/0244; A61H 2003/007; A61H 2003/0222; A61H 2003/025; A61H 2201/1673

(57) ABSTRACT

This invention relates to a cane/crutch accessory, arranged to be fastened near a distal end (13) of a cane/crutch (11) or similar also equipped with a ferrule (12), by means of a fastening means (5, 17), optionally including adaptor ring/s (15), which accessory includes an arm (28) protruding from said fastening means (5, 17) and a hook-shaped member (6) protruding at an angle in relation to said arm (28), thereby creating a simple grasping device with no moving parts between the arm (6) and the ferrule (12), wherein said arm (6) preferably having a ramp profile (28) to avoid getting caught in objects.

### CROSS REFERENCE TO RELATED APPLICATIONS

The application claims priority to and the benefit of patent Application Serial No. 2150240-6, entitled “A MULTI-FUNCTIONAL MAGNETIC CLIP, HOOK, AND PEDAL DEVICE FOR CRUTCHES, CANES AND OTHER STICK-LIKE OBJECTS”, filed on Mar. 3, 2021 and PCT Application Serial No. PCT/SE2022/050208, entitled “A MULTI-FUNCTIONAL MAGNETIC CLIP, HOOK, AND PEDAL DEVICE FOR CRUTCHES, CANES AND OTHER STICK-LIKE OBJECTS”, filed on Mar. 2, 2022, the disclosures of which are incorporated herein by reference in its entirety.

### TECHNICAL FIELD

This invention primarily relates to an aid for retrieving stick-like objects which have fallen to the floor, especially objects like walking canes or crutches for persons of limited mobility. It also relates to a means of fixing two stick-like objects together for storage, ease of transport, etc.

### BACKGROUND

A walking cane is typically a shaft with a handle at the top or proximal end, and rubber tip or “ferrule” at the bottom or distal end, often used to support people with limited mobility. A crutch is similar to a cane but has additional underarm support (axillary crutch) or forearm support (Lofstrand crutch, or platform crutch). Herein, the word “crutch” is often used to mean “Lofstrand crutch” but may also mean any type of walking cane, crutch, walking stick, staff or trekking pole. The words “cane” and “crutch” may sometimes be used interchangeably, and may be extended to mean any stick-like object.

One major deficiency of crutches is that they are notorious for tipping and falling to the ground which presents a nuisance for most users with limited mobility to retrieve them. Also, each crutch occupies one of the user's hands such that the user is not free to perform other tasks with their hands. Finally, when climbing stairs with two crutches, it is difficult to hold the handrail, leading many to climb stairs without doing so, increasing the risk of falling.

There has been much advancement to make canes which are more difficult to tip over by increasing friction at the point where the cane is leaned against the table, or by making the tip more stable or heavy. It is known that a wrist strap may be added to the cane handle to prevent it from falling while in use. Canes with multiple tips are known, such as tripod or quad canes. For example U.S. Pat. No. 5,566,700 teaches of a cane with a pair of laterally-displaced rounded plate tips. The purpose is to provide a cane which does not tip over as easily.

There has been advancement in cane storing technology: US 20080053501 A1 describes a magnet which clips to the upper portion of a cane shaft or is integral with the cane handle which allows the cane to be temporarily fastened to anything ferromagnetic, so that the cane does not fall over. Small ferromagnetic surfaces are provided which clip or adhere to furniture or walls in the home where needed. The magnet in the handle can be used to pick up keys or other ferromagnetic objects, if the user turns the cane upside down. The disadvantages are: that the home must be cluttered with small ferromagnetic objects in order to be of any help, that the user must turn the cane upside down to pick up keys and risk having no possibility of support during the manoeuvre. The magnets are not described to be used to attach one cane to another, neither for lifting one cane with another, nor to temporarily fix two canes together for easier transport. The device seems too small to allow forearm crutches to be temporarily fastened to each other or to walls, since the cuffs would interfere.

There has also been some advancement in cane-retrieving technology over recent years:

U.S. Pat. No. 5,865,204 teaches of a disc above a cane tip to aid in retrieving a cane which has fallen to the floor. The disc provides a fulcrum “2-3 inches above the base”, and stepping on the cane tip raises the handle-end of the cane to a first position “with sufficient clearance beneath the shaft to allow the person's second foot to be inserted between this and the floor.” The user must then attempt to lift the proximal end of the cane to a second position by sliding the feet together. The cane is then retrieved. This presents deficiencies: Firstly, stepping on the round tip could cause the cane to roll and the user to lose their footing and fall. Secondly, standing unsupported while sliding the feet together to lift the cane is not a manoeuvre many people with limited mobility could accomplish.

A product called “The Superior Cane Tip”, herein referred to as “Superior Tip”, can be found online by “Gathering Dust LTD” which is a rubber cane tip with an integral 3-inch diameter horizontal disc forming the ferrule tip. When the cane falls over, the disc edge will touch the ground forming a fulcrum while the opposite portion of the disc is elevated. Stepping on the elevated portion of the disc thereby lifts the proximal-end of the cane.

U.S. Pat. No. 9,084,458 B2, herein referred to by its product name “HurryCane”, describes a tripod cane. In one of their instructional videos, a lifting function is described whereby the HurryCane tip can be stepped on to lift the cane up in a similar manner as that described for Superior Tip.

U.S. Pat. No. 6,220,262B1 relates to a crutch with a handle which curved out of plane, which can be stepped on to lift the cane. One major disadvantage is that it does not hold the forearm as a forearm crutch can. In an alternate embodiment, the device can also be used as a ferrule.

Herein, prior art devices like HurryCane, Superior Tip and U.S. Pat. No. 6,220,262B1 especially when used as a ferrule will be called “Special Tip” devices. Further deficiencies with most Special Tip devices:

none of the devices allow the use of standard replacement ferrules. Instead, the consumer is required to purchase Special Tip replacements from the manufacturer.

these devices are unstable and may roll when stepped on, causing loss of balance and possible injury.

They are bulky and may cause the user to stumble on them, or even get their clothing caught.

none are compatible with existing winter cleat accessories (e.g. Ingrid or DMI).

none have a built-in means of arresting the motion of the cane once it reaches a vertical position, besides catching it. So, if the user does not catch the cane, it will either strike the user, typically at high speed, or fall over again. A fair degree of skill is involved to avoid this “stepping on a garden rake” phenomenon, as the geometry creates an ever-increasing mechanical advantage and ever-decreasing load torque due to gravity.

none adequately mitigate the risk of the cane falling over in the first place,

none provide any alternate methods of picking up the cane by means other than stepping by the foot, a manoeuvre which may be impossible for people with a leg injury.

There has also been advancement in the area of freeing one hand in order to climb stairs. The designer Richard Child published a new crutch design online https://www.trendhunter.com/trends/magnetic-crutch-clips where two forearm crutches are temporarily fastened to each other using magnetic clips in order to climb stairs safely while holding the handrail. However, in his solution, one of the crutches forearm cuffs must be folded away in order to accommodate the close proximity of the joined crutches; in other words, the crutches themselves must be specially designed to enable this function, and an additional two steps must be taken: folding away one of the cuffs, and folding it back into position again after stairs are traversed. When temporarily fastened, the crutches are close beside each other but with their handles pointing in opposite directions, which makes attaching/detaching the crutches awkward. The mating magnetic surfaces are not augmented against slipping using any sort of relief, leading to the need for a rather large pair of magnets. Finally, one crutch is dedicated to always carry the other. This means that, the user must occasionally hold the crutches with the carried crutch inward (a cumbersome arrangement).

Finally, a cane combined with a grabber is known, for example US2015305452 teaches of a spring-loaded grabber attached to the distal end of a cane. This, and several similar examples in the prior art have the disadvantage of having many moving parts, often with cables or rods leading from the handle to the gripper to actuate the gripper, with their inherit complexity comes additional costs to manufacture.

### SUMMARY

It is the object of the current invention to:

Provide a new method for lifting crutches from the floor to a substantially vertical position in a stable manner for easy retrieval and a pedal-like device to enable this method.

Enable the device to fit canes/crutches of various types and sizes.

Not interfere with the use of standard replacement ferrules.

Not interfere with the use of standard winter cleats.

Reduce the overall effort and degree of skill required to use the device compared to Special Tip devices in the prior art.

Provide alternate means to retrieve one crutch using another crutch equipped with the device, or with any ferromagnetic object hanging from a wrist strap or key chain.

Provide a safer means to pick up ferromagnetic objects, such as keys.

Allow a pair of crutches to be temporarily fastened to each other so they may benefit from increased stability when leaned against a wall or table, and so that they may be used/held/transported with one hand, leaving the other hand free.

Provide the means and a new method for enabling the user to hold the handrail while climbing stairs by temporarily fastening two crutches together.

Provide a simple means to convert a crutch into a primitive grasping tool to manipulate objects, open doors, pick up non-ferromagnetic objects, etc.

It is the aim of the present invention to eliminate or at least minimize the deficiencies listed concerning the prior art, and to achieve at least one of the objects presented which is accomplished by a device according to the claims.

The device includes a pair of pedals fastened to either side of a crutch, preferably near the crutch tip. The pedals include an arm and a stirrup with a flat tread. If the crutch falls and lies horizontally, then the prone pedal will rest facing the floor/ground and act as a fulcrum, and the other is the supine pedal. By stepping on the tread or effort point of the supine pedal, to apply a small, substantially constant, downward force, the crutch may be lifted by lever action from the ground, to a substantially vertical position, where it will stay until grasped. This is herein known as the “step-to-lift” function.

Once lifted from the floor, the crutch can be held in position with the foot indefinitely, providing a “hands-free” function.

According to further aspects of the invention;

The device can be fastened to a crutch of any diameter by mounting one of several provided adapter rings around the crutch shaft before the device is mounted.

The device is preferably an independent accessory, attached to any crutch shaft, and therefore does not interfere with the choice of crutch or replacement ferrules.

The device will not interfere with most existing models of winter cleats: neither those which are integral to the ferrule, nor those which are mounted to the crutch shaft and fold into position below the ferrule.

Through geometry, the device may facilitate the step-to-lift function compared to the prior art by:

Providing a substantial horizontal offset between the effort point and the fulcrum, giving good mechanical advantage initially while the crutch is lying.

Reducing or managing the mechanical advantage as the crutch is lifted, to reduce or eliminate the runaway condition.

Providing an interference to arrest the motion and prevent overshoot as the crutch reaches the vertical position, further reducing the runaway condition.

Providing a wide fulcrum such that the fulcrum is a line not a point, to give stability in roll.

Reducing the distance from the ground to the effort point so that the user can leave the heel of their actuating foot planted during lifting.

One or preferably two or more magnets (or temporary fastening means) placed strategically on the arm of the device may have multiple advantages. When a person uses two crutches, both equipped with the device, they may use one crutch to lift the other fallen crutch from the ground using the magnets. Secondly two crutches may be temporarily fastened using the magnets before leaning the crutches against a wall, to provide stability against falling over as easily. Thirdly, if both crutches are dropped, and the user cannot manage the step-to-lift function, they may instead use a provided ferromagnetic target object on a strap or key chain to retrieve their crutches. Finally, if the user dropped their keys, but has not dropped their crutch, the magnet embedded in the device may be used to safely retrieve them, without inverting their crutch.

In one of the alternate embodiments, called the “hook” embodiment, the pedal stirrup is removed leaving the magnets and a hook-shaped arm which holds them. The hook embodiment accomplishes most of the functions described above, plus additional functions: using two or more hook embodiments per crutch allows two crutches to be temporarily but firmly fastened via the magnets. The resulting “double crutch unit” can act as a single crutch for freeing up one hand while walking, ease of transport, or provide stability when leaned against a wall or table.

In addition, the double crutch unit may be useful when climbing stairs: with the unused crutch being transported “piggyback” on the supporting crutch, the user's other hand is free to hold the handrail.

With one hook embodiment mounted near the crutch handle, objects such as grocery bags may be hung. Magnets in the hook may also be used to temporarily fasten a magnetically anchored wrist strap, which may be worn to avoid dropping the crutch, but benefit from the “quick disconnect” provided by the magnets.

When a hook embodiment is mounted towards the distal end of the crutch shaft, it can be used to pick up some non-magnetic objects from the ground, like bags, purses or shoes. Turning door handles to open doors is also possible by using the hook and ferrule to provide a torque.

A “clip” embodiment reduces or eliminates the arm for use with other stick-like objects where the bulk of the forearm cuff is not a concern. A plurality of the clip embodiment can be used for example to attach a reacher/grabber to a crutch, or to attach a water bottle to a bicycle frame, or a broom to a dustpan, etc.

The “cuff” embodiment makes the device integral with the cuff of a forearm crutch.

### BRIEF DESCRIPTION OF THE DRAWINGS

The embodiments of the invention/device will hereinafter be described in more detail with reference to the attached diagrams in which:

FIG. 1 shows a top view of one half (one pedal) of the preferred embodiment.

FIG. 2 shows a perspective view of one half of the preferred embodiment.

FIG. 3 shows a side view of one half of the preferred embodiment.

FIG. 4 shows a front view of one half of the preferred embodiment.

FIG. 5 shows an exploded, perspective view of the preferred embodiment (both halves and fastening means) fastened to a crutch.

FIG. 6 shows a perspective view of the preferred embodiment fastened to a crutch.

FIGS. 7, 8 and 9 are front views, in chronological order, of the preferred embodiment and bottom portion of a cane with a person using the step-to-lift method to retrieve the cane:

FIG. 7 shows the first step,

FIG. 8 shows an intermediate position between the first and second steps, and

FIG. 9 shows the second step of the step-to-lift method.

FIG. 10 shows a flowchart of the 2-step method of the step-to-lift function used to lift and retrieve

the crutch using the preferred embodiment.

FIG. 11 graphs the typical step-to-lift force schedule for a forearm crutch using the preferred embodiment.

FIG. 12 is a perspective view showing the “hook” alternate embodiment fastened to a cane.

FIG. 13 shows the second step of the step-to-lift method using the “hook” embodiment.

FIG. 14 is a perspective view showing the “square” alternate embodiment.

FIG. 15 is a perspective view showing the “round” alternate embodiment.

FIG. 16 shows a perspective view of the “cuff” alternative embodiment where the device is integrated into the cuff of a forearm crutch.

FIGS. 17 and 18 show front views, in chronological order, of the upper portion of a fallen crutch with the cuff embodiment and a user employing the step-to-lift method to retrieve it.

FIG. 17 shows the first step.

FIG. 18 shows an intermediate position between the first and second step of the step-to-lift method. (The second step is not shown for the sake of brevity)

FIG. 19 shows the preferred embodiment being retrieved using a set of keys.

FIG. 20 shows the preferred embodiment being used to retrieve a set of keys.

FIG. 21 shows how the preferred embodiment, when attached to two canes, can enable a user to

retrieve one fallen cane with another.

FIG. 22 shows how the “hook” embodiment can be used to open a door.

FIG. 23 shows how the “hook” embodiment can temporarily fasten two crutches together into a single unit, such that the crutches can be carried in one hand.

FIG. 24 shows how the “cuff” and preferred embodiments can be used together to temporarily fasten two crutches together into a single unit, such that the crutches can be leaned together against a wall or a table.

FIG. 25 shows various relief patterns of interlocking features which serve to augment the strength of the magnets.

FIGS. 26 and 27 show a rear view of the “hook” and preferred embodiment being used on a pair of crutches while the user walks up a set of stairs using the method described:

FIG. 26 shows step 5.i, and

FIG. 27 shows step 5.ii of the stair climbing method (ascending case).

FIG. 28 shows an exploded, perspective view of the “hook” embodiment and fastening means,

mounted near the proximal end of a cane.

FIG. 29 shows a perspective view of the “hook” embodiment fastened to a cane with a ferromagnetic target and wrist strap around the user's wrist.

FIG. 30 shows the clip embodiment, a pair of which can be used to temporarily fasten any two stick-like objects together, or to fasten a stick-like object to a wheelchair, a bicycle frame, furniture, a reacher/grabber etc.

### DETAILED DESCRIPTION

The device is a multi-functional crutch accessory primarily concerned with: assisting the user in retrieving a crutch which has fallen to the floor, using a crutch to retrieve other objects which have fallen, or temporarily fastening two crutches together when at least one crutch is not in use—either in order to increase their stability so that they will not fall when leaned against a wall or table, or in order to allow the user to conveniently carry, using one hand, two crutches temporarily fastened to each other as a single unit. This is also beneficial when the user climbs stairs, leaving one hand free to hold the handrail.

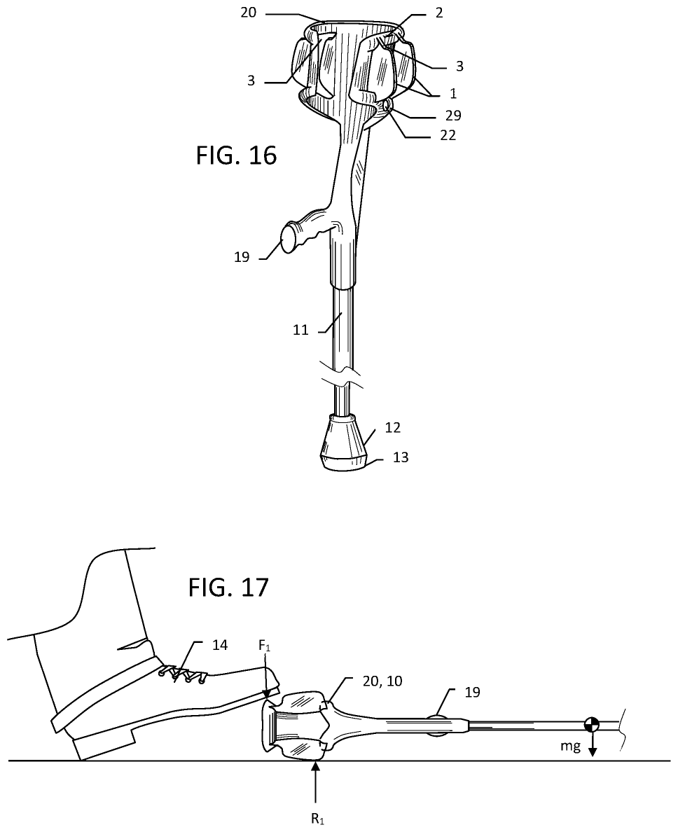

Referring to FIG. 16, a crutch includes a crutch shaft (11), a rubber ferrule (12) fixed at a bottom/distal end (13) and a handle (19) fixed at the top/proximal end. The term “crutch shaft” (11) will sometimes be used to mean the entire crutch.

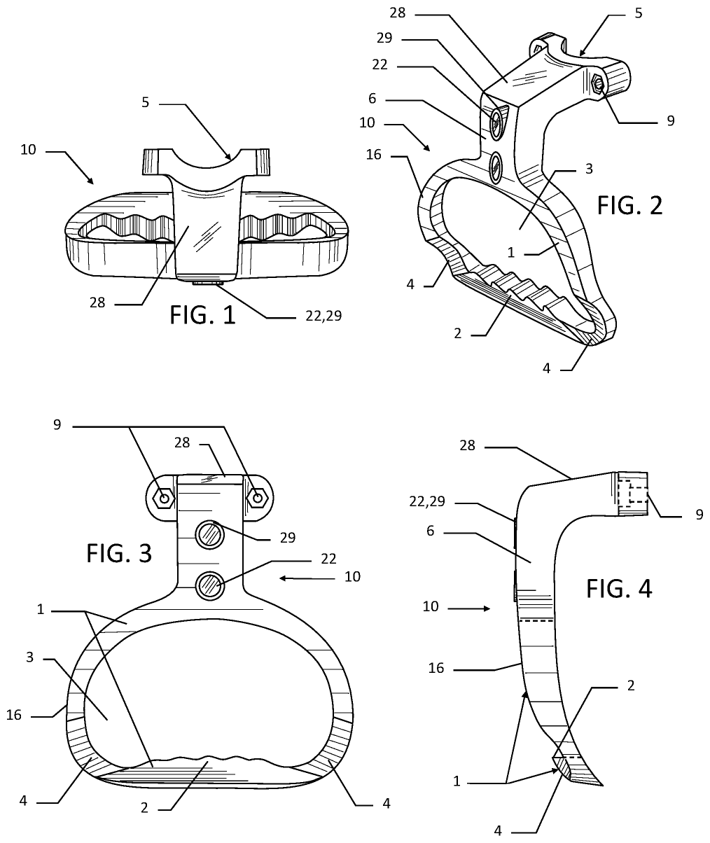

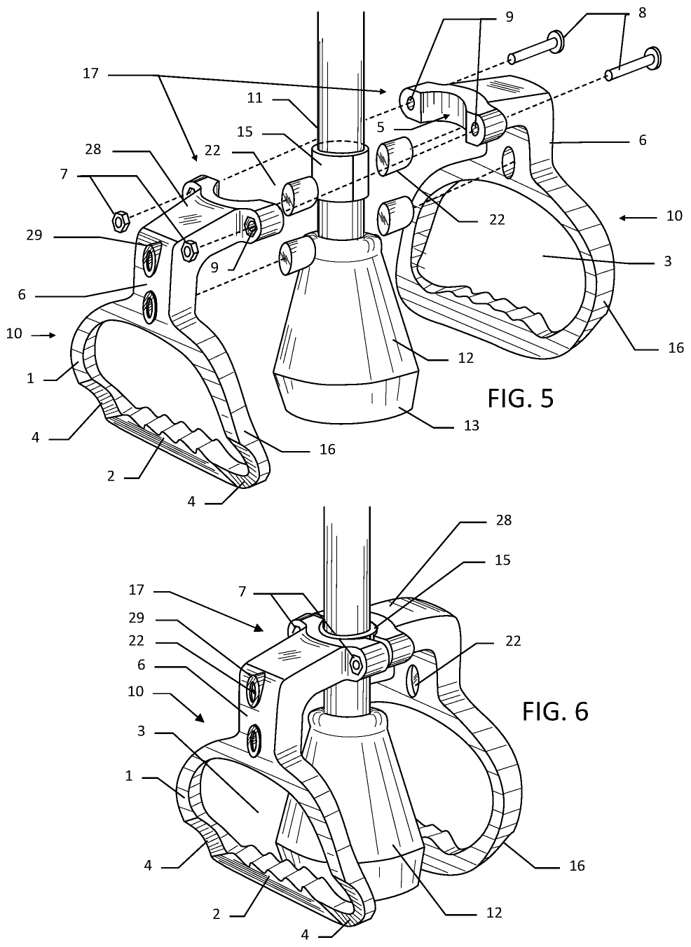

The preferred embodiment comprises a set of two identical pedal halves (10). The pedal half (10) is shown in detail in FIGS. 1-4. FIGS. 5-6 show how the two pedal halves (10) clamp together to create a fastening means (17). The pedal (10) of each half includes a proximal portion of an arm (28) a distal portion of said arm (6) and a stirrup (16). On each pedal half (10), the fastening means (17) serves to attach the proximal end of the arm (28) to the crutch shaft (11) preferably mounted just above the ferrule (12). The stirrup (16) is attached to the distal end of the arm (6). The device is so attached such that the stirrup (16) is near but not touching the floor while the crutch (11) is standing vertically. One purpose of the pair of pedals halves (10) is to provide a means to lift the crutch using a step-to-lift method as will be described later.

Referring especially to FIGS. 5 and 6, the fastening means (17) includes a pair of clamping surfaces (5) and one or more bolt holes (9) which allow one or more bolts (8) and corresponding nuts (7) to be secured as shown. Tightening the nuts (7) and bolts (8), brings together the opposing clamping surfaces (5) to capture the crutch shaft (11). The bolt holes (9) preferably have a hexagonal counterbore to prevent the nuts from rotating during assembly.

The proximal portion of the arm (28) and/or the clamp (5) has a sloped surface feature or ramp (28) to act as a shed to decrease friction and thereby help avoid getting caught on, for example, the underside of stair tread nosings, foreign objects, the user's own clothing etc while walking with the crutches.

Since crutch shafts (11) occur in various diameters, mounting of the device to the crutch shaft (11) is preferably facilitated by an adapter ring (15), which is inserted between the clamping surfaces (5) and the crutch shaft (11). Several sizes of adapter ring (15) may be provided. Alternatively, or in combination, rubber sheets of various thicknesses or tape may be provided for this purpose.

The adapter ring (15) is preferably fashioned as two halves, divided longitudinally, to simplify manufacturing and assembly, and so that the ferrule (12) need not be removed to install the device or the adapter ring (15).

FIG. 3 shows that the stirrup (16) is preferably substantially “D”-shaped forming a foot hole (3). The flattened portion of the stirrup (16) provides a tread (2).

When mounted, the device is aligned with the handle (19) such that when the crutch and its handle lie on the ground there will be a downward-facing or prone pedal (10), and an upward-facing or supine pedal (10).

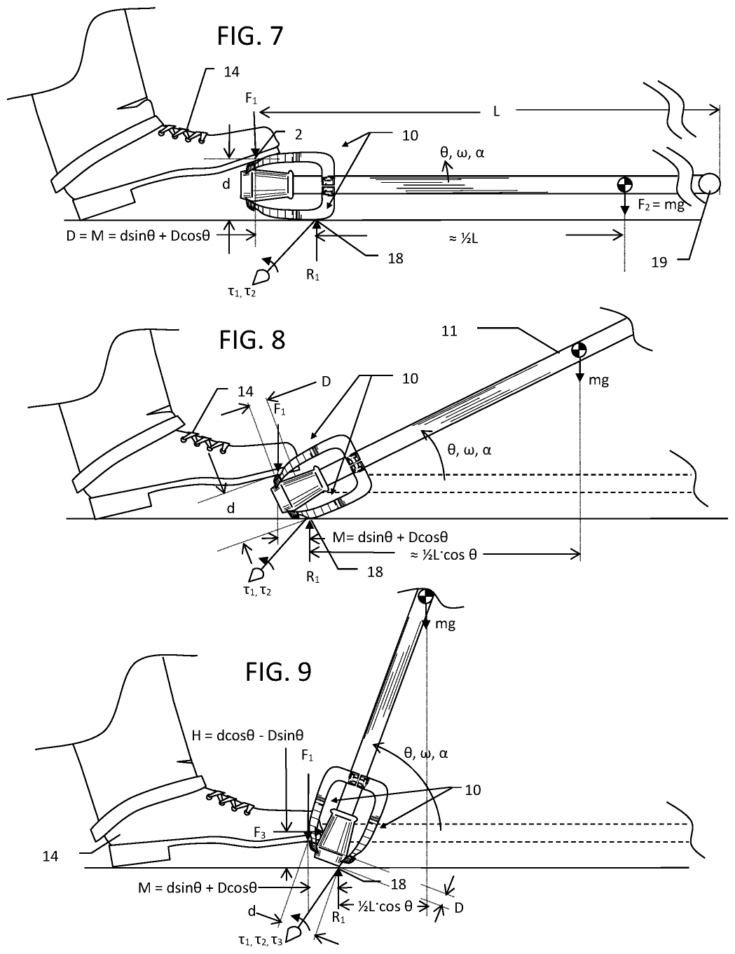

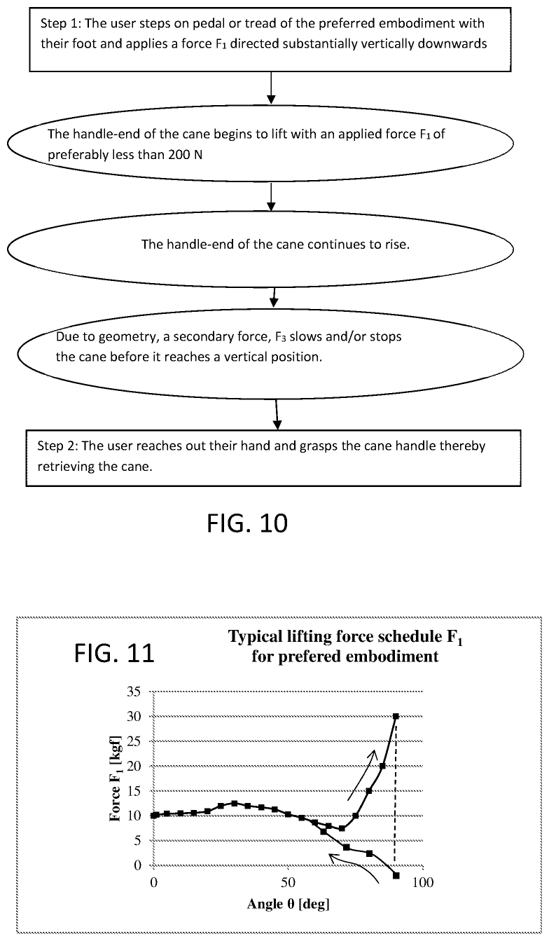

Referring to FIG. 7, the tread (2) on the supine pedal (10) is for the user to step on with the toe, heel, or ball of a foot (14).

Referring to FIG. 6, the outermost surface of each pedal (10) is preferably shaped like a sector or quadrant of an elliptic cylinder and creates a rolling fulcrum surface (1) when in contact with the ground. This surface may in fact be discontinuous and portions of it may be located on the distal portion of the arm (6), the stirrup (16), the tread (2) or even the ferrule (12).

Referring to FIGS. 7, 8, 9, 17 & 18, the point, or line, where the prone pedal's rolling fulcrum surface (1) contacts the floor forms an instantaneous fulcrum (18). The fulcrum surface (1) is of sufficient width to provide lateral (roll) stability.

The tread (2) is located an instantaneous displacement (D) away from the fulcrum (18) along the axis of the crutch shaft (11), and an instantaneous displacement (d) perpendicular to the axis of the crutch shaft (11) as shown. The tread (2) is the effort point of the class-1 lever system thus created. Applying a sufficient vertical force (F1) to the tread (2) will cause the crutch to accelerate with an angular acceleration (α) with an angular velocity (ω) to an elevation angle (θ) about the fulcrum (18) with respect to the floor. A reaction force (R1) acts through the fulcrum (18). The fulcrum (18) is preferably not located at any fixed position, but advantageously moves along the rolling fulcrum surface (1) depending on said surface geometry and the elevation angle (θ). This is to manage the mechanical advantage of the effort point or tread (2) as the crutch shaft (11) is lifted, especially during the first 60 degrees of the elevation angle (θ). The fulcrum surface (1) curvature is designed to reduce mechanical advantage to prevent a runaway condition and to “even out” the required forces (F1) to lift the crutch shaft (11) as compared to the prior art.

Consider a crutch with a mass (m) and an angular moment of inertia (I). An in-depth analysis of the physics behind the preferred embodiment's interaction with a crutch begins with a variation of Newton's second law (F=ma) when applied to rotating bodies:

Στ=Iα

### Where:

Σ is the summation operator,

τ is an applied torque about the fulcrum,

I the moment of inertia of the crutch, and

α is the crutch's resulting angular acceleration.

For the situation depicted in FIGS. 7, 8 and 9, Newton's second law can be expressed as:

τ1+τ2+τ3=Iα

A first torque (τ1) is applied by stepping on the tread (2) with a force (F1). A second torque (τ2) is due to gravity (F2=mg) acting on the crutch shaft (11). A third torque (τ3) is due to an arresting force (F3) where the crutch nears vertical (over ca. 60°, see FIG. 9) and the user's foot (14) begins interfering either with the ferrule (12), the shaft (11), the stirrup sides (16), and/or the ferrule (12) touches the floor. The torques can be written as:

$$τ1 = M \cdot F 1 = ( d \cdot sin θ + D \cdot cos θ ) \cdot F 1$$

$$τ2 = - \frac{1}{2} mgL \cdot cos θ$$

$$\begin{matrix}0 & if θ < 60 ° \\ - F 3 \cdot H \pm μ F 3 \cdot d & if θ \geq 60 °\end{matrix}$$

### Where:

θ is the pitch angle of the crutch shaft (11),

m is the mass of the crutch shaft (11),

L is the length of the crutch shaft (11),

g is the local gravity of Earth,

M is an instantaneous horizontal moment arm between fulcrum (18) and tread (2),

H is an instantaneous vertical distance between fulcrum (18) and tread (2),

μ is a coefficient of friction between the user's foot (14) and the stirrup (16),

F3 is the arresting force. In this case, the user's foot (14) acting on the stirrup (16),

and the “±” indicates the friction force acts opposite to the direction of motion.

Assuming that the force (F1) is sufficient to move the crutch, then to keep the angular velocity (ω) constant, the angular acceleration (α) must be zero. And the force (F3) is only a function of the elevation angle (θ) and a spring constant. Substituting gives an equation for the force (F1) as a function of (θ):

τ1+τ2+τ3=0

(d·sin θ+D·cos θ)·F1−½mgL·cos θ=0 if θ<60°

(d·sin θ+D·cos θe)·F1−½ mgL·cos θ−k·θ(H±μ·d)=0 if θ≥60°

Where (k) is a combined spring constant of the sole of the user's shoe (14), and the flexing of the stirrup (16), the ferrule's (12) interference with the floor, etc.

Now solving for F1:

F1=(½ mgL·cos θ)/(d·sin θ+D·cos θ) if θ<60°

F1=(½ mgL·cos θ+k·θ((dcos θ−D sin θ)±μ·d))/(d·sin θ+D·cos θ) if θ≥60°

Note that (d), (D), (M), and (H) are instantaneous variables, not constants, and are themselves functions of (θ) and dependent on the curvature of the fulcrum surface (1).

The typical required force (F1) for the preferred embodiment is graphed in FIG. 11. The preferred embodiment does not require a great force (F1) to begin motion, and the magnitude of the required force (F1) does not decrease significantly with elevation angle (θ) leading to the runaway condition as in the prior art. Instead, the forces (F1) are substantially constant; approximately 100 N, or 10 kgf, trending towards greater forces as elevation angle (θ) increases beyond 60 degrees, as the arresting force (F3) comes into effect. The intention of the geometry is to reduce the moment (M) with increasing angles (θ). In fact D takes on a negative value in FIG. 9, contributing to this reduction.

The friction occurring at angles greater than 60° near the end of travel helps to dampen the motion so that the spring constant (k) does not simply bounce the device back downwards. This causes the hysteresis of the graph of FIG. 11.

A pair of side cut-outs (4) allow the user's foot (14) to penetrate deeper into the stirrup toe hole (3) for added grip.

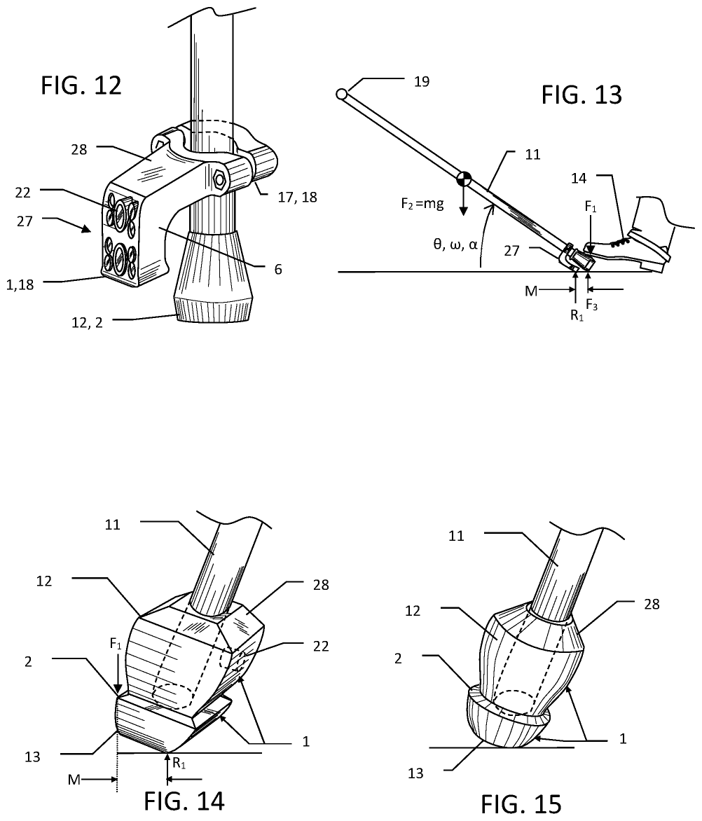

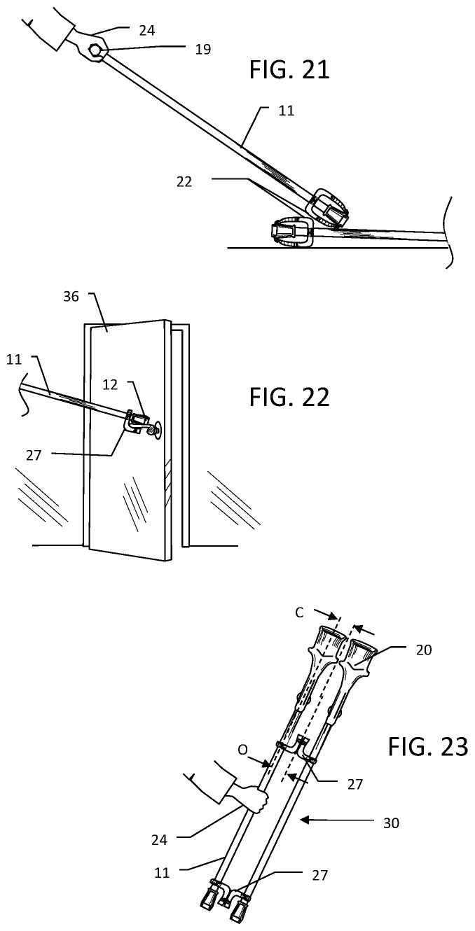

FIGS. 12 and 13—discussion moved to after FIG. 21.

FIG. 14 depicts the “square” alternate embodiment where the device is made integral with the rubber ferrule (12). The rolling fulcrum surfaces (1) exist on all 4 sides of the square-sectioned ferrule and these surfaces are recessed to provide the treads (2). The interplay between each tread (2) and the curvature of the fulcrum surface (1) is arranged such to produce a moment (M) from the fulcrum (18) which is initially large, but reduces with increasing angle (θ) as in the preferred embodiment. The tread (2) and fulcrum (18) are straight to increase stability in roll.

FIG. 15 depicts the “round” alternate embodiment which is like FIG. 14 but round. This embodiment has the advantage of appearing more like traditional ferrules, but lacks stability in roll.

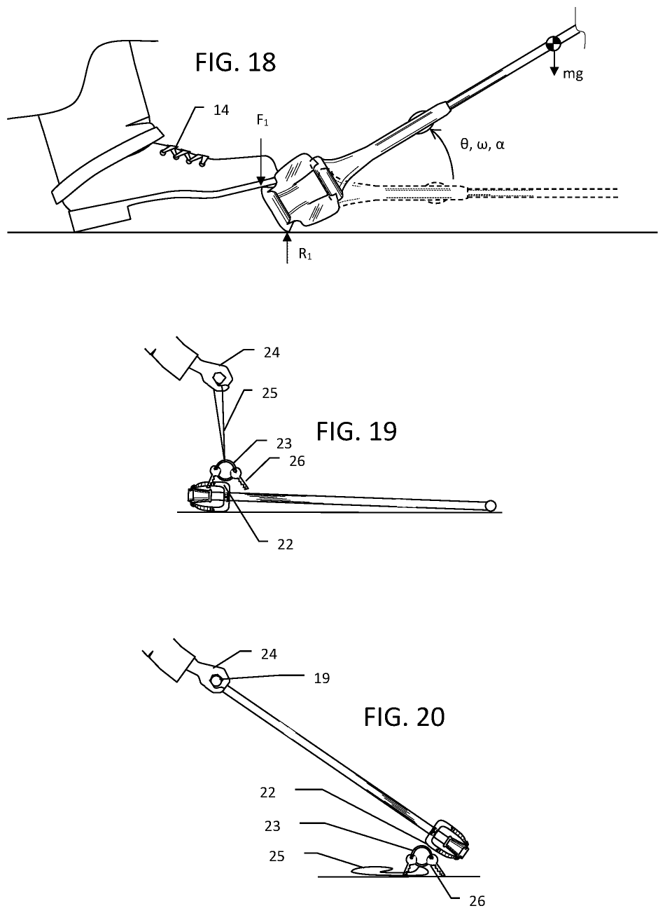

FIGS. 16, 17, and 18 show an alternate embodiment where the pedal is made integral with a forearm cuff (20), above the handle (19) of a forearm crutch. By slightly modifying the shape of the exterior of the cuff (20), a pair of flanges creates the rolling fulcrum surfaces (1) and toe holes (3) on either side.

For people who have inured one leg, using the device as described so far may still be difficult or impossible. Rather than a single cane/crutch, people with more severely limited mobility generally use a pair of crutches. To further enhance the usefulness of the device, it must be possible to lift one or both crutches in another way. This can be done in many ways thanks to the invention.

An alternate method to lift one crutch with another is made possible by a temporary fastening means (22). Referring again to FIGS. 1 to 6, one or temporary fastening means (22) are attached to the distal portion of the arm (6) or alternately on the stirrup (16). When a crutch equipped with the device is brought into proximity of another equipped crutch, it causes the temporary fastening means of each device (22) to attach to each other allowing one crutch to be lifted by the other, as shown in FIG. 21. The temporary fastening means (22) are preferably one or more nickel-plated neodymium magnets, with their magnetic poles aligned and arranged to create attractive forces, but may alternately take any equivalent form such as: hook and loop fasteners, mushroom fasteners, adhesives, etc. The magnets are preferably held by press fitting from the inside of the device into the distal portion of the arm (6) and captured on the outside by an integral magnet holder (29). It is foreseen that this feature may be the subject for its own protection, e.g. in a divisional application, without use of a step-to-lift function device.

The magnet holders (29) preferably include a relatively large but thin flange on the mating side to prevent the magnets (22) from working lose and falling out. The magnet holders (29) also absorb impact forces when two devices “click” together. These impact forces may otherwise damage the magnets.

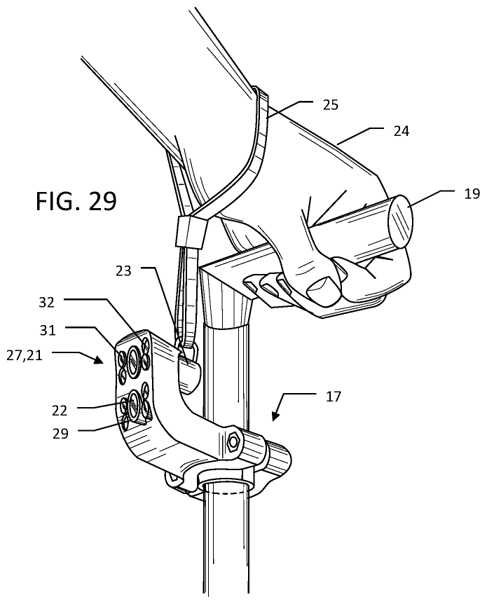

Another function of the magnets (22) is illustrated in FIG. 19: if a crutch is dropped by the user, and the user has a strap or key chain (25) attached to a key ring (23) perhaps attached to a set of keys (26) or if the user has a wrist strap (25) attached to a provided ferromagnetic target (23), as shown in FIG. 29, then they can retrieve both crutches with the method shown. Another convenient method may be to remove one's belt, and if the buckle is ferromagnetic, “fish” up the crutch using the belt.

Compared to the prior art of mounting magnets near the cane handle, the positioning of the temporary fastening means (22) near the crutch's distal end (13) has several additional advantages: Firstly, if one crutch was dropped by a user, it is the tip end, not the handle, which is often nearest the user, and therefore easiest to reach for magnetic pick-up. Secondly, while retrieving a fallen crutch, as in FIG. 21 or fallen keys as in FIG. 20, the user can keep the crutch they are holding in a substantially vertical orientation and need not invert their crutch as with the prior art, which exposes the user to risk of being without support. Finally, the distal end (13) is generally lighter than the handle/proximal end, so less magnetic force is required to retrieve the crutch as shown in FIGS. 19 and 21. This function requires a very high magnetic holding strength, as only one pair of magnets are engaging, and because the magnets are not face-to-face. At least 10 N of holding force is required, but preferably about 30 N. This retrieval function has not been found in the prior art, possibly due to the extremely strong magnets required, and associated high cost.

FIG. 12 shows an alternate “hook” embodiment (27). The rolling fulcrum surface (1) is significantly sharper than the preferred embodiment's, but still significantly wide to reduce roll about the axis of the crutch shaft (11). The hook embodiment (27) located in this distal position along the cane shaft (11) provides a hook function allowing the user to pick up objects which may be non-ferromagnetic, such as bags, shoes, towels, etc.

As shown in FIG. 13, by using the ferrule (12) as the tread (2), there is a significant displacement (M) between the tread (2) and the fulcrum (18) which reduces required forces (F1) applied by the user's foot (14) to lift the crutch (11) compared to special tip devices in the prior art. In addition, because of the length of the distal portion of the arm (6), and therefore lower positioning of the rolling fulcrum (1) the crutch (11) may be brought to a much higher angle (θ) than U.S. Pat. No. 5,865,204 disc fulcrum, suitable for grasping without the user needing to bend over or manipulate the crutch further with their feet.

When the crutch (11) falls, the weight of the handle (19) will often give said crutch (11) the correct orientation. If not, it is relatively easy to provide a small kick to turn the crutch over to the correct orientation (with the hook embodiment facing down) before the step-to-lift method is used.

Referring to FIG. 22, the “hook” embodiment (27) is used together with the ferrule (12) to twist a door handle to open/close a door (36). The handle fits between the distal, hook-shaped portion of the arm (6) and the ferrule (12) and/or crutch shaft (11). The user may then twist the crutch (11) along its shaft and turn the door handle, and pull/push the door (36) open/closed. The advantage is that opening/closing the door becomes easier since the crutch (11) does not need to be set aside, risking falling over, but becomes a primitive grasping tool like an extension of the user's own hand.

The same twisting motion used to open a door handle can be used to capture/grasp some objects. The twisting of the crutch shaft causes an apparent reduction of the space between the ferrule (12) and hook embodiment's (27) distal portion of arm (6) with respect to the object thereby augmenting said arm's “hook” function, the advantage being that the user saves bending over, and that there are no moving parts which may break, and cost money to produce/assemble as a proper reacher/grabber would have. In addition, the user does not need to squeeze a handle to apply a grasping force, but instead merely twists the handle (19) to hook/grab the object.

FIG. 23 shows how two crutches with 4 hook embodiments (27) can be used to temporarily bind two crutches together into a double crutch unit (30), where said crutches (11) are substantially parallel to each other. The strength in the magnets is preferably high, at least 10 N for each pair of hooks, such that the pair of crutches (11) may be carried together as a crutch unit (30) with a single hand, and the crutch unit (30) will remain together despite disturbances from everyday situations, like bumping into door frames, etc. There is a synergy in the arrangement in that, when mounted on a pair of forearm crutches, the length of the proximal portion of the arm (28) allows the fastening means (22) of the hook embodiment (27) to reach each other and engage, despite the bulk of the forearm cuffs (20). This is due to the distance (O) between the fastening means mating surface and the crutch centreline (11) being greater than the distance (C) between the cuff inner edge and said crutch centreline (11). It is also extremely advantageous that the crutch handles (19) may act as levers to easily pry the powerful magnets (22) apart.

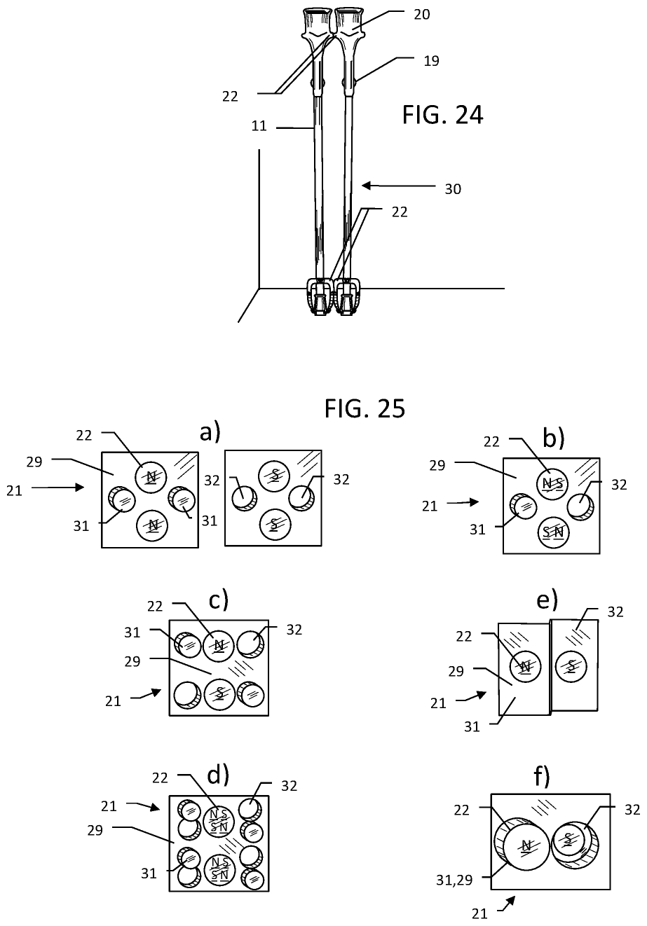

FIG. 24 shows the preferred embodiment and an alternate placement location of the temporary fastening means (22) in the forearm crutch cuff (20) to temporarily bind two crutches into the double crutch unit (30). This location is also shown in FIG. 16. Another advantage of the crutch unit (30) is that the crutches may be leaned against a wall together with added stability against tipping and falling over. The large length of the proximal portion of arm (28) directly causing the distance (O) in order to clear the forearm cuffs (20) serendipitously causes the ferrules (12) of the double crutch unit (30) to be spaced widely apart providing a wide base. This means the arrangement is stable and does not topple over easily while leaning like this.

Another advantageous synergy is that the hands-free feature described earlier for the preferred embodiment is further enhanced because a single foot (14) may be used to support the entire double crutch unit (30), freeing both of the user's hands.

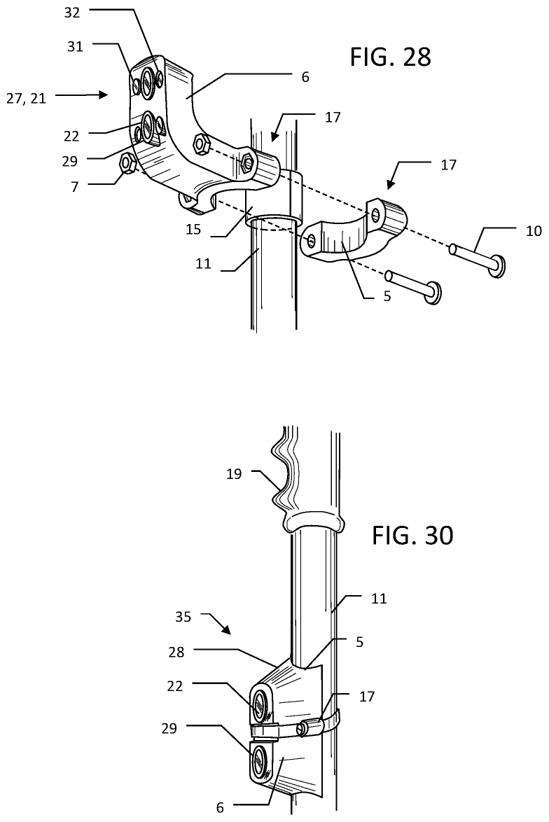

FIG. 25—discussion moved to after FIG. 28.

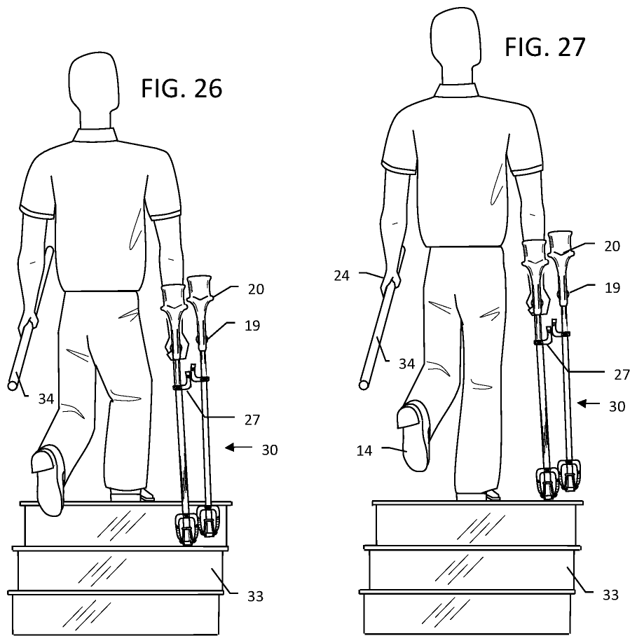

FIGS. 26 and 27 shows how the crutch unit (30) can be used according to the method described below when climbing a staircase (33), as it frees one hand to grasp a handrail (34) while the other hand uses the support of the crutch unit (30). FIG. 26 shows step 5.i and FIG. 27 shows step 5.ii of the stair climbing method. It is known fact that holding the handrail while climbing stairs is statistically much safer than not doing so.

A method of climbing the set of stairs (33) using two crutches (11), each equipped with two examples of the device, mounted initially outwards, is described comprising the steps:
The user ambulates to the first stair of the staircase (33).
The user stands on their good leg while binding the crutches together into the double crutch unit (30) using the temporary fastening means (22).
The user holds the handrail (34) with their nearest hand (24). If there are two handrails (34), then the handrail on the same side as the injury is preferred.
The user supports themselves with the handrail (34) in one hand (24) and the crutch unit (30) in the other.
If ascending:
with their good leg, the user steps up to the next step, which becomes the current step.
the user's bad leg and crutch unit (30) are lifted to the current step
repeat from step 5.i until the top of the staircase (33) is reached.
If descending:
With their bad leg, the user steps down to the next step, which becomes the current step.
the user “hops” down with their good leg to the current step
repeat from step 6.i until the bottom of the staircase (33) is reached.
The user disassembles the crutch unit (30) by prying the handles (19) apart and continues walking with two individual crutches (11).

Because of the serendipitous use of a plurality of vertically-spaced magnets on each embodiment, the user may have the option to affix the crutches (11) to each other in an offset fashion, thereby keeping the ferrule (12) of the unused crutch well away from the floor/stairs (33). When going down stairs, assuming the staircase has handrails (34) on both sides, the arrangement can be switched so that the unused crutch becomes the supporting crutch and vice versa. This allows the user to hold the crutch (11) with the correct handed palm grip, in case the crutches (11) are equipped with these, and hold the handrail (34) with the hand (24) on the same side as the injured leg for better support.

Alternatively, the polarity of one pair of magnets (22) can be reversed to specifically prevent this from happening, such that the crutches (11) will always align correctly when leaning against a wall, etc.

FIG. 28 shows an exploded view of the hook embodiment (27). Note that the second half of the device is no longer needed except to fulfil its purpose as a fastening means (17). The residual part preferably includes the clamping surface (5) and bolt holes (9) to fulfil this function.

Referring still to FIG. 28, the performance of the temporary fastening means/magnets (22) can be augmented by adding a relief pattern (21) to the contacting surfaces of the distal portion of arm (6) and/or magnet holder (29) and/or the magnets themselves (22). The relief pattern (21), preferably a set of small protuberances (31) and depressions (32), is designed to mate/interlock and thereby restrict the motion of two devices sliding relative to each other while temporarily fastened. Alternately, a rough or knurled surface may be used to increase friction. Alternately, a high friction material like rubber can be used. The protuberances (31) and depressions (32) can be of any shape: cylinders, cubes, prisms, etc. and of any number. The advantage of the relief pattern (21) can be leveraged so that either a smaller/less-powerful magnet (22) can be used, saving on magnet costs, or that the holding strength (primarily in the sheering direction) is increased for improved functionality.

The term “hermaphroditic” is used herein, borrowed from the electrical connector industry and will be used to mean “genderless”, “sexless”, “mates with itself” characterized by “possessing both male and female elements such that mating parts are exactly alike”

FIG. 25 shows several alternate relief patterns (21) and polarisation examples for the magnets (22). FIG. 25 a) is gendered, and not hermaphroditic, meaning that devices with “male” protuberances (31) can only mate with devices with “female” depressions (32).

A magnetic north pole (N) is attracted to a magnetic south pole (S), but like poles repel. There are therefore a limited number of polarisations which will be attractive. It is possible to polarise magnets axially (as shown in FIG. 25 a, c, e and f) or diametrically (as in FIG. 25 b) or even so-called multipolar (as shown in FIG. 25 d). The magnetic polarisation (N, S) shown in FIGS. 25 a) to f) are examples, but alternate combinations are possible. For example, the arrangement of the relief pattern (21) shown in FIG. 25 d) may be combined with the polarization (N, S) of the magnets (22) shown in FIG. 25 c).

The set of protuberances (31) and depressions (32) are preferably hermaphroditic such that an identical mould can be used to create both the mating parts, and to provide greater opportunities for interoperability for example by temporarily fastening crutches to a “docking station” as will be described below. Patterns FIG. 25 b) to f) are hermaphroditic as are the polarisations (N, S) of the magnets (22), except not FIG. 25 c).

There are several variations and combinations of magnet polarizations and relief patterns besides those shown. It is possible for example to increase or decrease the numbers of magnets (22), protuberances (31) and depressions (32). It is possible to substitute some of the magnets with iron or similar “soft” ferromagnetic materials (which do not tend to stay magnetized).

The set of protuberances (31) and depressions (32) is also preferably able to be inverted by 180 degrees, so that a crutch unit (30) can be created with one crutch inverted with respect to the other. This is possible with relief patterns (21) and polarisations (N, S) shown in FIG. 25 d), and may also be possible with FIG. 25 c) if the polarisations of two of the devices are reversed.

It is also preferable to support offsetting the crutches, in either the up or down direction, to allow the user the option to keep the unused crutch's ferrule (12) away from the floor while climbing stairs as described earlier and shown in FIGS. 26 and 27. The pattern (21) and polarisations (N, S) shown in FIG. 25 d) can accommodate this. This is the preferred relief pattern, since it is hermaphroditic, invertible, and offsettable.

Referring to FIG. 29, the preferred relief pattern (21) is shown. Also shown is the use of the strap (25) holding the ferromagnetic target (23) to help avoid dropping the crutch (11) while in use. The target (23) is preferably not a magnet itself, but only ferromagnetic, such that polarisation is irrelevant when mating/interlocking with the rear side of the hook embodiment (27). The advantage of mating with the rear side is that the target (23) will not interfere when creating the double crutch unit (30). One advantage of using a ferromagnetic target (23) is the possibility to disconnect quickly by simply pulling the strap (25) with sufficient force.

A clip embodiment (35) as shown in FIG. 30 may be used to temporarily fasten crutches (11) or other stick-like objects to wall/furniture-mounted clips located strategically around the home, acting as “docking stations”. The clip (35) can alternatively be used to temporarily fasten crutches (11) or other stick-like objects to other mobility aids such as a wheelchair, walker, scooter or bicycle.

The clip (35), to save manufacturing costs associated with providing nuts (7) and bolts (8) and two opposing clamping surfaces (5), can alternately use a hose clamp or tie wrap as a fastening means (17) which wraps around the clip embodiment and the object it is fastened to. The hose clamp (17) is preferably captured between the two magnet holders (29). For improved stability and compactness, the distal and proximal portions of the arm are effectively merged such that the short clip arm (6, 28) becomes a thick platform shape providing a housing for the magnets (22) and a sloped ramp (28).

The clip embodiment's clamping surface (5) is preferably parabolic-shaped but alternately triangular, to match a large variety of crutch shaft (11) diameters. The use of this shape avoids the need for adapter rings (15).

It is foreseen that specific features may be the subject for its own protection, e.g. in a divisional application, without use of the features as described above, e.g. the step-to-lift function devices may of course be used without temporary fastening means 22, as also is true for the clip embodiment 35 that may be used without the step-to-lift function devices.

### LIST OF PARTS AND DETAILS

1 rolling fulcrum surface
2 tread/effort point
3 foot hole
4 side cut outs
5 clamping surface
6 distal, hook-shaped portion of arm
7 nut
8 bolt
9 bolt hole
10 pedal/pedal half
11 crutch/cane or crutch/cane shaft
12 rubber ferrule
13 crutch distal end
14 user's foot
15 adapter ring
16 stirrup or lower portion of pedal
17 fastening means
18 fulcrum/instantaneous fulcrum
19 handle
20 forearm cuff
21 relief pattern/mating surface
22 temporary fastening means/magnet
23 magnetic/ferromagnetic target or key ring
24 user's hand
25 wrist strap or key chain
26 key or other object
27 hook embodiment
28 proximal portion of arm (preferably sloping or having surface ramp feature)
29 magnet holder
30 double crutch unit
31 protuberence
32 depression
33 staircase
34 handrail
35 clip embodiment
36 door

### LIST OF SYMBOLS USED

θ elevation/pitch angle of the crutch (11) with respect to the ground/floor
ω angular velocity of the crutch (11) in pitch direction
α angular acceleration of the crutch (11) in pitch direction
τ torque acting on the crutch (11) about its fulcrum (18)
d instantaneous axial displacement between fulcrum (18) and tread (2)
D instantaneous longitudinal displacement between fulcrum (18) and tread (2)
H instantaneous vertical displacement between fulcrum (18) and tread (2)
M instantaneous horizontal displacement between fulcrum (18) and tread (2)
O axial displacement between temporary fastening means (22)/mating surface (21) and crutch shaft centreline (11)
C axial displacement between cuff inner edge (20) and shaft centreline (11)
μ coefficient of friction between the user's foot (14) and the device
k angular spring constant between the user's foot (14) and the device
m mass of the crutch (11)
g gravitational field strength of Earth
F₁ The downward force applied by the user's foot (14) at the tread/effort point (2)
F₂ The downward force of gravity on the centre of mass of the crutch (11)
F₃ The horizontal force applied by the user's foot (14) on the stirrup (16) and tip (12)
R₁ The reaction force from the ground at the fulcrum (18)
N The north pole of the magnet (22)
S The south pole of the magnet (22)

1. A crutch accessory apparatus, arranged to be fastened near a distal end (13) of the crutch apparatus (11) having a ferrule (12) also located at said distal end (13), the crutch accessory apparatus comprising:
a fastening means (5, 17);
an L-shaped arm wherein the proximal portion of said arm (28) protrudes from said fastening means (5, 17) and a hook-shaped and the distal portion of said arm (6) protruding at an angle in relation to proximal portion of said arm (28);
wherein the L-shaped arm is configured to be a grasping tool, thereby creating a simple hook device with no moving parts capable of retrieving objects between the distal arm (6) and the distal end (13) and the ferrule of the crutch apparatus.

2. The crutch accessory apparatus of claim 1 further comprising a temporary fastening means (22) configured to attach to said distal arm (6), with said temporary fasting means (22), including one or more magnets.

3. The crutch accessory apparatus of claim 1 wherein said distal arm (6) further comprises a fulcrum surface (1) located on the outward-facing surface of said distal arm (6) with respect to the crutch shaft (11) and making contact with the ground along said fulcrum surface (1) at a rolling fulcrum point (18) creating a lever, wherein the fulcrum surface (1) is arranged such that as a user (14) applies a downwards force (F1) to the crutch distal end (13) or ferrule (12) a torque (τ) is produced, which is initially large, but reduces with increasing angle (θ) which reduces required forces (F₁) applied by the user's foot (14) to lift the crutch (11).

4. The crutch accessory apparatus of claim 2 is arranged be used in quantities of 2 or more per cane/crutch in combination with a second crutch apparatus, wherein said arm (28) is of sufficient length that the axial displacement (O) between the temporary fastening means (22) and crutch shaft centreline (O) is slightly greater than the axial distance (C) between the cuff (20) inner edge and the crutch shaft centreline (11) for a typical crutch.

5. A crutch accessory apparatus of claim 2 wherein said magnets (22) are augmented by an interlocking relief pattern (21) arranged to increase the holding strength of said magnets (22) in the sheer direction.

6. The crutch accessory apparatus of claim 5 wherein said interlocking relief pattern (21) is hermaphroditic in order to give greater freedom of interoperability with a plurality of other embodiments (27, 35), wherein the hermaphroditic interlocking patterns (21) are so designed to be mirrored in both the X and Y axis so that that the two crutches (11) may be rotated by 180 degrees and still interlock, allowing one crutch to be connected upside-down compared with the other, and more preferred that the pattern (21) and polarization (N, S) is repetitive in such a way as to allow the shifting/offsetting of the mating pairs longitudinally.

7. The crutch accessory apparatus of claim 2 is further configured with one “hook” embodiment (27) near the distal end and one “cuff” embodiment being integral with the cuff (20) of a forearm crutch.

8. The crutch accessory apparatus of claim 2 wherein said arm (28) is shortened and fastening means (17) is wider, creating the low-profile clip embodiment (35) in order to arrange for temporarily attachment means for joining other stick-like objects such as walking sticks which do not have cuffs.

9. The crutch accessory apparatus of claim 1 further comprising an accompanying wrist strap (25) and a target (23) arranged to work together with the hook embodiment (27) or clip embodiment (35) to temporarily fasten a user's wrist to a crutch or any stick-like device.

10. The crutch accessory apparatus of claim 1 wherein the apparatus is made of rubber and integral with said crutch distal end (13) or rubber tip or ferrule (12).

11. The crutch accessory apparatus of claim 1 wherein said proximal arm (28) is configured to be sloped or has a ramp profile to avoid getting caught in objects.

12. The crutch accessory apparatus of claim 2 wherein the strength of the magnets is at least 10 N holding force per pair in order to keep the crutches together.

13. The crutch accessory apparatus of claim 3, wherein said fulcrum surface (1) is curved.

14. The crutch accessory apparatus of claim 1 further configured to support a cane.
